(19) United States
(12) Patent Application Publication
(10) Pub. No.: US 2025/0153103 A1
(43) Pub. Date: May 15, 2025

(54) DIRECT AIR CAPTURE AND LIQUID ENVIRONMENT DESORPTION PROCESS

(71) Applicant: SPIRITUS TECHNOLOGIES, PBC, White Rock, NM (US)

(72) Inventors: Matthew Nicholson Lee, Los Alamos, NM (US); Jose Manuel Tafoya, Santa Fe, NM (US); Daniel Francis Opila, Bethesda, MD (US); Jon Rau, Santa Fe, NM (US); Emily Webster Tew, White Rock, NM (US); Matthew Douglass Crall, White Rock, NM (US); Charles Frederick Cadieu, Burlingame, CA (US); Benjamin Peter Warner, Los Alamos, NM (US)

(73) Assignee: SPIRITUS TECHNOLOGIES, PBC, White Rock, NM (US)

(21) Appl. No.: 18/508,160

(22) Filed: Nov. 13, 2023

(51) Int. Cl. B01D 53/96; B01D 53/62; B01D 53/82; C01B 32/50

(52) U.S. Cl. CPC B01D 53/96; B01D 53/62; B01D 53/82; C01B 32/50; B01D 2257/504; B01D 2259/4009; B01D 2259/40092

(57) ABSTRACT

Direct air capture of a gas followed by liquid phase desorption includes contacting a sorbent material with a gas and chemically reacting gas molecules with the sorbent material. The chemical reaction is reversed in a liquid phase environment so as to release gas molecules and regenerate the sorbent while the sorbent material remains in the liquid phase environment. Finally, the desorbed gas molecules are captured for sequestration.

### BACKGROUND OF THE INVENTION

### Field of the Invention

The present invention relates to the field of gas capture through an adsorption and desorption process in which desorption occurs in a liquid environment.

### Description of the Related Art

Adsorption refers to the increase in concentration of a substance at an interface of a condensed phase and a liquid phase owing to the operation of surface forces. More concretely, adsorption is the adhesion of molecules of gas, liquid, or dissolved solids to a surface. The adsorption process results in the creation of a film of an adsorbate upon a surface of an adsorbent. Adsorption differs from absorption in which one substance permeates another. For instance, whereas adsorption can be characterized as a surface phenomenon, absorption involves the whole volume of the material. Like surface tension, adsorption is a consequence of surface energy.

Adsorption capitalizes upon the tendency of one or more components of a liquid or gas to collect on the surface of a solid. This tendency can be leveraged to remove solutes from a liquid or gas or to separate components that have different affinities for the solid. The process objective may be either waste treatment or the purification of valuable components of a feed stream. In an adsorption process, the solid is called the adsorbent and the solute is known as the adsorbate. Opposite to the process of adsorption is desorption. In desorption, the atomic or molecular species forming the adsorbate leaves the surface of the adsorbent and escapes into the surrounding environment. Generally, the adsorbate leaves the surface of the adsorbent when the molecules of the adsorbate gain enough energy to overcome the threshold of the bounding energy binding the adsorbate to the surface of the adsorbent.

Many techniques are known for promoting desorption—particularly of a gas—but the most common techniques include some combination of heating a chamber encapsulating a gas environment in which the adsorbent substrate is placed in order to impart enough energy upon the adsorbate to promote the breaking of the adsorption forces. In many instances, where it is desirable to capture the adsorbate upon desorption without contaminating the adsorbate upon desorption, a vacuum can be applied to the chamber during heating so that the adsorbate once released from the adsorbent is free in the chamber from contamination. The use of a vacuum, however, introduces significant problems. One problem is the operational difficulties of constructing vacuum systems and maintaining their integrity during repeated use. Another problem is that heat transfer is difficult in a vacuum, so heating the adsorbent substrate to release the adsorbate is inefficient.

Desorption is not limited to a gas environment, though. Indeed, desorption in a liquid environment such as water also is known. However, contemporary water based desorption protocols present problems including a need to heat and cool the water of the water environment, which has a high energy cost. This high energy cost in turn renders water based desorption unfeasible and suitable only for lab scale demonstration projects. At the economically viable production scale, though, water based desorption has not proven to be a suitable solution.

### BRIEF SUMMARY OF THE INVENTION

Embodiments of the present invention address deficiencies of the art in respect to direct air capture of a gas and provide a novel and non-obvious method and apparatus for direct air capture of a gas utilizing a hybrid approach of gas phase adsorption and liquid phase desorption. In an embodiment of the invention, a direct air capture method with liquid phase desorption includes contacting a sorbent material with a gas and chemically reacting gas molecules with the sorbent material. The method additionally includes transferring the sorbent material into a liquid phase environment and reversing the chemical reaction to release gas molecules and regenerate the sorbent while the sorbent material remains in the liquid phase environment. Finally, the method includes capturing the desorbed gas molecules.

Other aspects of the embodiment may include alone or in combination the following:
Reacting the desorbed gas molecules with a metal oxide during the capturing of the desorbed gas molecules.
Contacting the gas with the sorbent material in a gas phase environment that is Earth atmosphere.
Performing the reversing by applying heat energy to the sorbent material and then cooling the sorbent material
Spraying the sorbent material with heated liquid as part of the transferring step.

Of note, in one aspect of the embodiment, the liquid phase environment is contained in a container and optionally includes water. In another aspect of the embodiment, the contained liquid phase environment has a headspace; after the adsorbate is released, the headspace is preferably at least 25% released adsorbate. Importantly, the headspace acts as a filter to ensure that gas traversing the liquid phase environment into the headspace excludes unwanted contaminates such as nitrogen or oxygen thereby assuring a separation of the adsorbate, for instance CO₂, from air. In yet another aspect of the embodiment, the released gas is collected in portion of the container. In even yet another aspect of the embodiment, the sorbent material is separated from the liquid phase environment after completion of the desorption and the sorbent material is then dried.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of process for direct air capture of a gas utilizing a hybrid approach of gas phase adsorption and liquid phase desorption;

FIG. 2 is a pictorial illustration of an alternative process for direct air capture of a gas utilizing a hybrid approach of gas phase adsorption and liquid phase desorption; and,

FIG. 3 is a flow chart illustrating a process for direct air capture of a gas utilizing a hybrid approach of gas phase adsorption and liquid phase desorption.

### DETAILED DESCRIPTION OF THE INVENTION

In accordance with an embodiment of the inventive arrangements, direct air capture of a gas utilizing a hybrid approach of gas phase adsorption and liquid phase desorption includes the placement of a sorbent into a gas environment such as Earth atmosphere and the provocation of gas adsorption of a gas such as CO₂ as an adsorbate. The sorbent can be placed into a liquid environment such as water and desorption can be triggered as a reversal of adsorption, for instance by introducing thermal energy into the liquid environment. The adsorbate upon desorption traverses the liquid environment and may be captured, either in a gas environment headspace external to the liquid environment, or onto an additional sorbent surface such as a mineralizing sorbent. The sorbent is then removed from the liquid environment and re-introduced to the gas environment for further adsorption of the gas. Optionally, the sorbent is permitted to dry in part or in full prior to re-introduction into the gas environment.

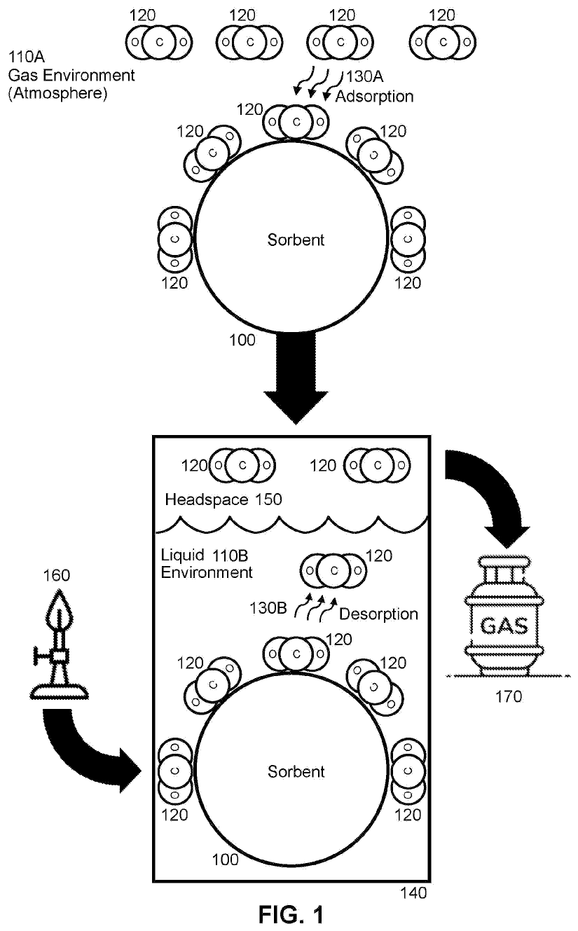

In further illustration, FIG. 1 is pictorial illustration of process for direct air capture of a gas utilizing a hybrid approach of gas phase adsorption and liquid phase desorption. As shown in FIG. 1, a sorbent 100 is placed into a gas environment 110A such as Earth atmosphere and gas adsorption 130A of CO₂ 120 is provoked such as through the mechanical movement of the CO₂ 120 across surface elements of the sorbent 100. Thereafter, the sorbent 100 is transferred to a liquid environment 110B contained within chamber 140, and the reversal of the adsorption 130A is performed through desorption 130B. In this regard, the desorption 130B is performed through the addition of energy 160 to a sorbent 100. In consequence of the desorption 130B, the previously adsorbed CO₂ 120 traverses the liquid environment 110B into a gas headspace 150 of the desorption chamber 140. Preferably, the CO₂ 120 in the headspace 150 should consume at least 25% of the headspace 150. Once in the headspace 150, the CO₂ 120 is transferred to long term storage 170.

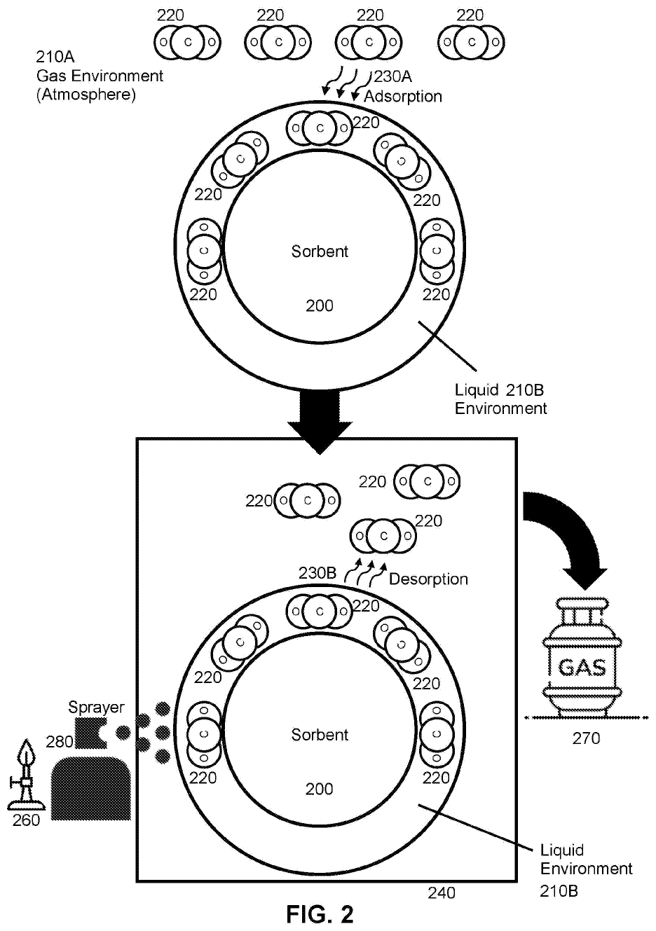

Turning now to FIG. 2, a pictorial illustration is provided of an alternative process for direct air capture of a gas utilizing a hybrid approach of gas phase adsorption and liquid phase desorption. As shown in FIG. 2, a sorbent 200 is placed into a gas environment 210A such as Earth atmosphere. Gas adsorption 230A of CO₂ 220 is provoked such as through the mechanical movement of the CO₂ 120 across surface elements of the sorbent 200. Thereafter, the sorbent 200 is transferred to a desorption chamber 240, and a sprayer 280 coats surface portions of the sorbent 200 with a layer of liquid such as water heated by heater 260 in order to produce a heated liquid environment 210 enveloping the sorbent 200. The reversal of the adsorption 230A is performed through desorption 230B resulting from the transfer of heat energy from the liquid environment 210. In consequence of the desorption 230B, the previously adsorbed CO₂ 220 traverses the liquid environment 210B into the desorption chamber 240. Once desorbed, the CO₂ 220 is transferred to long term storage 270.

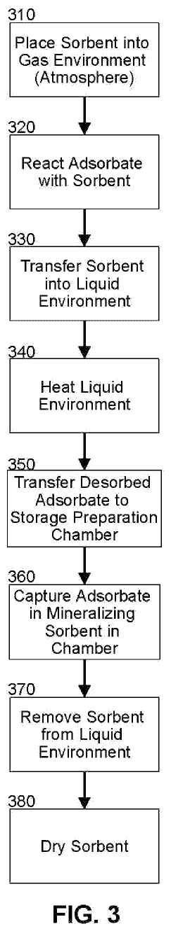

In even yet further illustration of the process for direct air capture of a gas utilizing a hybrid approach of gas phase adsorption and liquid phase desorption, FIG. 3 is a flow chart illustrating a process for direct air capture of a gas utilizing a hybrid approach of gas phase adsorption and liquid phase desorption. Beginning in block 310, sorbent is placed into a gas environment such as Earth atmosphere and in block 320, a gas within the gas environment chemically reacts with sorbent to form a gas-sorbent complex. The sorbent optionally includes multiple binding sites for gas. The presence of multiple binding sites allows the sorbent to have the controlled uptake of multiple aliquots of gas uptake and/or the controlled release of multiple aliquots of released gas.

In the event that the sorbent includes multiple binding sites for gas 110, at least one of the pairs of binding sites should have a difference between their binding enthalpy for gas of at least 20 KJ/mol; this difference allows the convenient control of the release of multiple aliquots of released gas. This difference in binding enthalpy may be conveniently obtained by using a sorbent material that forms a mixture of at least two functional groups selected from the set of carbamate, carbamic acid, ammonium bicarbonate, and ammonium carbonate. The chemical reaction between gas and the sorbent material to form a gas-sorbent complex need not run to thermodynamic equilibrium. Likewise, the reverse reaction to release released gas and regenerate the sorbent similarly need not run to thermodynamic equilibrium.

In block 330, the gas-sorbent complex is then transferred to a liquid environment such as water or an alcohol solution. In block 340, the chemical reaction between the gas and sorbent is reversed, for instance by introducing thermal energy into the gas-sorbent complex, in order to release the gas from the sorbent and to regenerate the sorbent. The thermal energy may be applied by direct contact with a liquid, either via immersion, spraying or otherwise contacting the gas-sorbent complex with a liquid. Examples of this liquid may be water, oil, alcohol or other options. The liquid may be a mixture or contain additives. Heat may also be applied by contact with a heated gas, gas mixture, or humid gas containing water vapor. The gas-sorbent complex may also be heated via radiative heat transfer via infrared, microwave, or similar radiation. Heat may also by applied by conduction by direct contact with a heated surface. Heat may also be applied by the use of steam, where the heat is transferred to the gas-sorbent complex by spraying or otherwise contacting the gas-sorbent complex with steam.

To the extent that heat is applied to the gas-sorbent complex in order to reverse the adsorption, the sorbent may then be cooled. Advantageously, by cooling the sorbent, heat energy present in the sorbent may be recycled for re-use. Further, the sorbent can be recycled for re-use with a minimization of decomposition of the sorbent which otherwise results from prolonged elevated temperatures of the sorbent. In block 350, the released gas is then captured in a storage preparation chamber and then, in block 360 the released adsorbate is optionally captured by a metal species to produce a metal carbonate, or by a mineralizing adsorbate by contacting the released gas with the mineralizing sorbent. The reaction between released gas and the mineralizing sorbent preferably is exothermic, and more preferably has an enthalpy of reaction of less than-178 KJ/mol. The second sorbent is preferably a chemical such as a calcium or magnesium silicates.

In one aspect of the embodiment, the capture of the released gas is preferably conducted at a temperature greater than 75° C., and more preferably performed at a temperature greater than 150° C. The capture of the released gas is preferably conducted at a pressure greater than 35 megapascals (MPa), and more preferably performed at a pressure greater than 70 MPa. The reaction between the released gas and the second sorbent preferably forms a metal carbonate, and more preferably forms a metal carbonate having a solubility in pure water of less than 15 ml/L at 25° C. In block 370, the sorbent is then removed from the desorption chamber and in block 380, the sorbent is optionally dried for reuse in gas adsorption. Optionally, the sorbent may be regenerated by contacting sorbent with a second aliquot of gas.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A direct air capture method comprising:
contacting a sorbent material with a gas;
chemically reacting gas molecules with the sorbent material;
reversing the chemical reaction within a liquid phase environment to release gas molecules and regenerate the sorbent; and,
capturing desorbed gas molecules.

2. The method of claim 1, further comprising transferring the sorbent material into the liquid phase environment prior to reversing the chemical reaction.

3. The method of claim 1, wherein the capturing of the desorbed gas molecules includes mineralizing the desorbed gas molecules.

4. The method of claim 1, wherein the liquid phase environment is contained in a container.

5. The method of claim 1, wherein the liquid phase environment comprises water.

6. The method of claim 1, wherein sorbent contacts the gas in a gas phase environment comprising Earth atmosphere.

7. The method of claim 1, wherein the reversing comprises applying heat energy to the sorbent material.

8. The method of claim 7, further comprising cooling the sorbent material subsequent to the application of the heat energy.

9. The method of claim 1, wherein the liquid phase environment comprises heated vapor sprayed onto the sorbent material.

10. The method of claim 1, further comprising separating the sorbent material from the liquid phase environment after completion of the desorption.
